(19) United States
(12) Patent Application Publication
(10) Pub. No.: US 2003/0099228 A1
(43) Pub. Date: May 29, 2003

(54) Local area and multimedia network using radio frequency transceivers and coaxial cable

(76) Inventor: Martin Alcock, Calgary (CA)

Correspondence Address: THOMAS E. MALYSZKO, SUITE 1500, 250 - 6 AVENUE, S.W., CALGARY, T2P 3H7, CA

(21) Appl. No.: 10/305,940

(22) Filed: Nov. 29, 2002

(30) Foreign Application Priority Data
Nov. 28, 2001 (CA) 2364133

(51) Int. Cl. H04L 12/66

(52) U.S. Cl. 370/353; 370/466

(57) ABSTRACT

A home or business-based local area network (LAN) architecture and system has an internal LAN that combines the distribution of two or more independently sourced classes of services, such as multimedia and data or telephone or access control, to multiple users within a single building, such as a house, hotel, multiple family dwelling or business/office building. A primary data service and a secondary service which may comprise analog or digital telephone service or access control is converted to a radio frequency that is then combined with multimedia entertainment services into a single local cable television network, carrying data, and analog and digitally encoded multimedia signals and telephone service. Terminals or devices connect to the LAN by means of a wall plate which performs the necessary interfacing between a terminal and the LAN, by separating the multimedia and LAN data services and telephone by means of a radio unit which is integrated into the wall plate. Separate connections are provided for data telephone, access control and multimedia interconnection.

### FIELD OF THE INVENTION

This invention relates to cable television and internet systems and to telephone internet services and, more particularly, to a system and apparatus for combining transmission of multimedia and computer data from a cable television or telephone line or both and redistributing the signals to a local area network.

### BACKGROUND OF THE INVENTION

Rapid advances in telecommunications and digital technology and desire to reduce the clutter of electronic cords, wires and set-top boxes have made it desirable to have a local area network in a building, such as a house or business, which can receive and convert diverse signals from varied outside services such that multiple devices in that building can be used to access multimedia and internet signals at the same time. The outside services could include interactive services, cable video and audio services, cable internet services, telephone company services, telephone internet and network services and other types of information services.

The need to share limited resources such as printers, scanners, data backup and Internet access in the home and business environments has created a demand for data and resource networking. This demand is coupled with concerns over limited choices in service providers. If all services introduced into a building were to be limited to just one service provider, such as the telephone company, there is reasonable apprehension that the user will not be paying the lowest competitive price for one or more of those services.

A further consideration is the ability of multiple users within, for example, a home to have access to the Internet at the same time and to use a common printer or data storage device that might be located physically distant to the user's location. There exists a need for an architecture and system which would permit multiple users to access multiple services at the same time without the need to install expensive and space-taking cables, wires or set top boxes to decipher and access these different types of data.

Canadian patent application 2,275,276 (referred to herein as '276) discloses an in-home network for distributing data such as video, audio or control data. To practise this invention it would be necessary to rely on a “set-top box”—a multi-media computer that augments the use of televisions with an external network interface module that connects to an external network and data provider. It would also be necessary for each individual device to connect to this set-top box directly or through a matrix. Unlike the present invention, in the '276 patent transmission of data and multimedia services to and from the terminals must flow through a central set-top box that preferentially connects to a digital broadband matrix. The network interface module is relatively expensive and there would need to be one set-top box for each end device.

Canadian patent application 2,238,394 ('394) discloses a home network architecture to introduce entertainment services into an internal digital network from an external source, making these services available to all terminals connected to the internal network. Unlike the present invention, the invention disclosed in the '394 application relies upon multiple set-top boxes and separate network interface units which are coupled together through a internal digital network installed in the home in order to provide interconnectivity at a reasonable cost to the consumer.

Canadian patent application 2,116,801 ('801) discloses a system for delivering audio and/or video signals in connection with the provision of interactive television services to users through a distribution system such as a cable television system or a telephone network. Unlike the present invention, the '801 application does not provide for, or contemplate, distribution of these services as part of a local area network so that the various users can be in communication with each other or can operate remote devices, such as a fax machine, individually.

Canadian patent 1,332,635 ('635), which is based on U.S. Pat. No. 1,332,635, discloses an apparatus for transmitting data over a cable television channel susceptible to interference noise wherein the transmitted data is spread over at least a portion of the spectrum of the cable television channel preferably in the “noisy” 0-30 megahertz upstream data transmission band of the cable television system spectrum. The present invention can be distinguished from the invention disclosed in the '635 patent in that the architecture refers to a means of encoding digital signals on a cable television network but does not contemplate use of analog signals as does the present invention.

U.S. Pat. No. 6,307,862 ('862) discloses a method and apparatus for monitoring and controlling a data network. The invention as disclosed uses new or existing cable television (“CATV”) coaxial cable to transmit to or receive data from devices coupled to an electronic control and monitoring system. This network could be installed in any structure and would provide for two-way communication between the devices. In the preferred embodiment certain cable channels are removed or stripped from the cable television signal and those selected or stripped channels are used to carry data signals and become data channels, with the remaining CATV channels and the data channels being combined to form a new CATV signal which is transmitted on a standard CATV cable. In order for the network to operate properly a minimum of two CATV channels must be stripped, the absence of these channels could provide a disruption to existing or planned services normally being distributed on the CATV cable.

### SUMMARY OF THE INVENTION

The present invention is a system and architecture comprised of a common standard coaxial medium that enters a building, such as a house, at a single point and then terminates in a multiplicity of endpoints throughout the building. The system is comprised of two components that include an access multiplexer which converts baseband data from a primary class of networks such as digital data, and/or a second class of service, which may originate as digital or analog telephone signals, and/or access control for multimedia services into a common local area network (LAN), and then to a radio frequency outside the set of frequencies in the range of 54-860 MHz, and may then also be combined with low voltage power onto a single CATV coaxial cable and then distributed in either a star and/or multidrop configuration to a multiplicity of termination points.

At each connection point a splitter separates the various signals being carried by the CATV cable, converts the data and/or second class of service to and from the said radio frequency and then the separated signals are relayed to their respective end points, such as a multimedia entertainment system via a standard coaxial cable, and/or a data terminal via a data cable, and/or a second terminal by a separate cable. All classes of services distributed throughout the building function independently, as if distributed on separate media, with concurrent two-way services to and from the various endpoints provided all classes of services. Additionally the data service connects to a common point permitting all data devices within the local area network to communicate with each other over the coaxial medium either in conjunction or independently with the operation of the plurality of multimedia entertainment systems and/or data terminals located at various and geographically diverse locations throughout the building.

This system is an improvement over existing systems that provide data and multimedia signals through separate and independent systems throughout a house or other building because the invention uses a frequency outside the common set of cable system frequencies (i.e. 54-860 MHz) and includes a second class or service, unlike other systems which use common frequency or frequencies, such as cable internet services, and may cause interference with said frequencies. The system is also capable of transmitting in both directions using the aforementioned frequency. The present invention is also an inventive improvement over the prior art in that the architecture of the wall plate in the present invention contains a radio frequency transceiver that converts the baseband data and/or a second class of service to and from the said radio frequency.

The addition of LAN functionality to an existing or new cable television network in a building such as a home facilitates sharing of devices such as printers, facsimile machines, gaming devices and other resources. The LAN may also be used for the distribution of services throughout the home.

A second embodiment of the wall plate can integrate a standard telephone jack, as well as the previously described services.

A third embodiment can integrate a data service for providing access to restricted television or other services that are accessed on a user pay basis.

Due to the nature of the LAN, many services can be simultaneously combined and distributed on a common medium. The invention includes and replaces set-top boxes, dedicated servers and interconnection hubs normally found in a network, thus affording a lower cost alternative which can be installed in a relatively short period of time using familiar tools and equipment. In the commercial building environment, this permits the use of personnel not necessarily trained in the art to perform installations, minimizes mysterious disappearance of equipment due to the fact that it is concealed in a wall outlet, and also reduces overall system cost by eliminating the need for set top boxes.

### BRIEF DESCRIPTION OF THE DRAWINGS

Embodiments of the invention will now be described, by way of example only, with reference to the accompanying drawings, wherein:

FIG. 1 shows a star configuration of the present invention;

FIG. 2 shows a multidrop configuration of the present invention;

FIG. 3a is a front view of a wall transceiver of the present invention; and, FIG. 3b is a side view of the transceiver of FIG. 3a.

### DESCRIPTION OF PREFERRED EMBODIMENTS

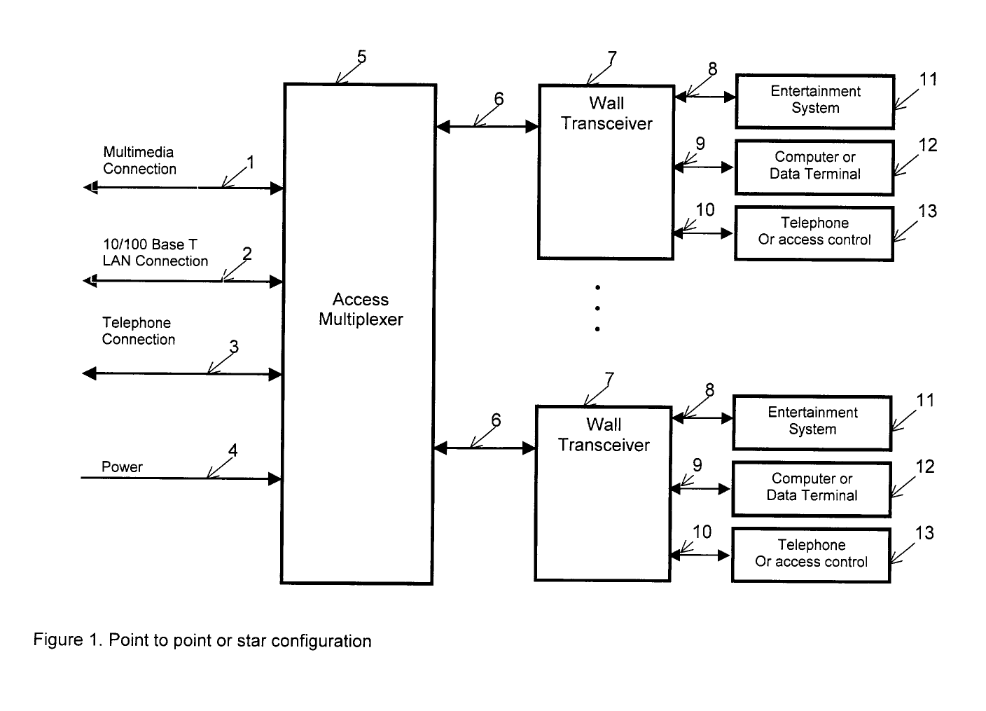

The invention is described in detail with reference to FIGS. 1 to 3b, in which like reference numerals refer to like elements.

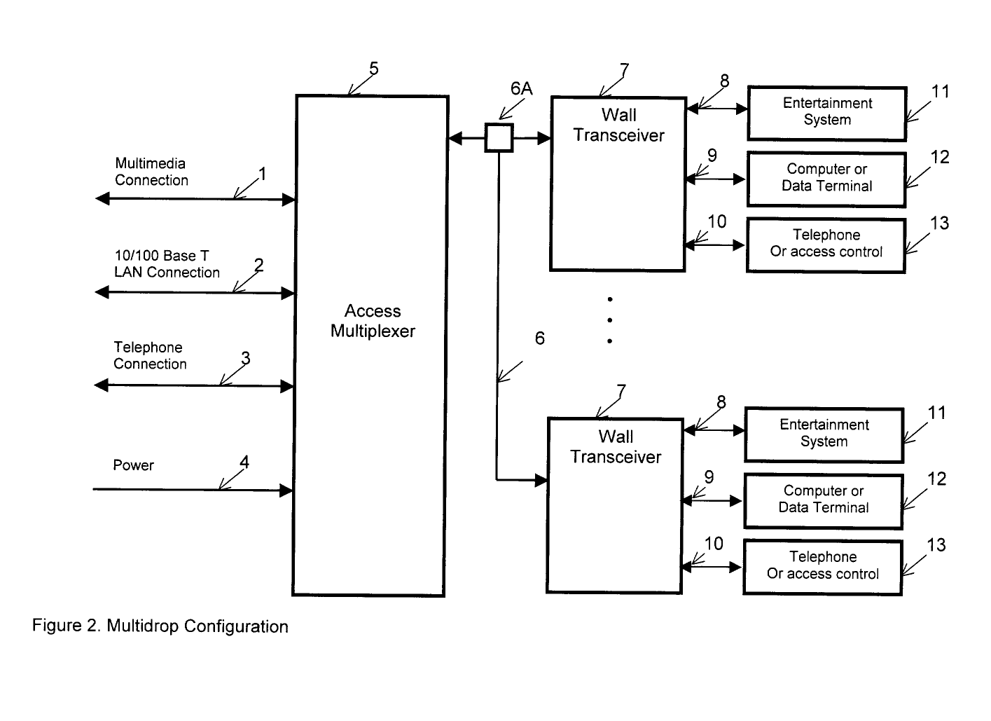

In general, FIG. 1 shows a star configuration where each wall transceiver is connected to an individual connector on the access multiplexer (5), and FIG. 2 shows a multidrop configuration using only a single connector at the multiplexer. In use, either one of or a combination of both of these techniques can be employed.

Referring now in more detail to FIG. 1, an in-home network is shown that combines an existing multimedia connection (1), a local area network connection (2), a telephone connection (3) and power (4) together onto a single coaxial cable (6), by using an access multiplexer (5). The cable is then connected to a wall mounted transceiver (7), which separates the previously multiplexed signals into a number of streams. A first stream comprises a multimedia signal (8), which is then connected to an entertainment system (11). A second stream comprises a local area network (9), which is then connected to one or more computers or data terminals (12). A third steam comprises a third connection (10) which may be connected to a telephone, or may provide another data service for providing access to restricted television or other services (13). In this configuration individual cables connect from the access multiplexer to the individual wall transceivers in a star configuration.

FIG. 2 shows another embodiment of the same network with the same connections as in the FIG. 1 embodiment, except that the wall transceivers are connected to the access multiplexer in a multidrop configuration using a cable splitter device (6A).

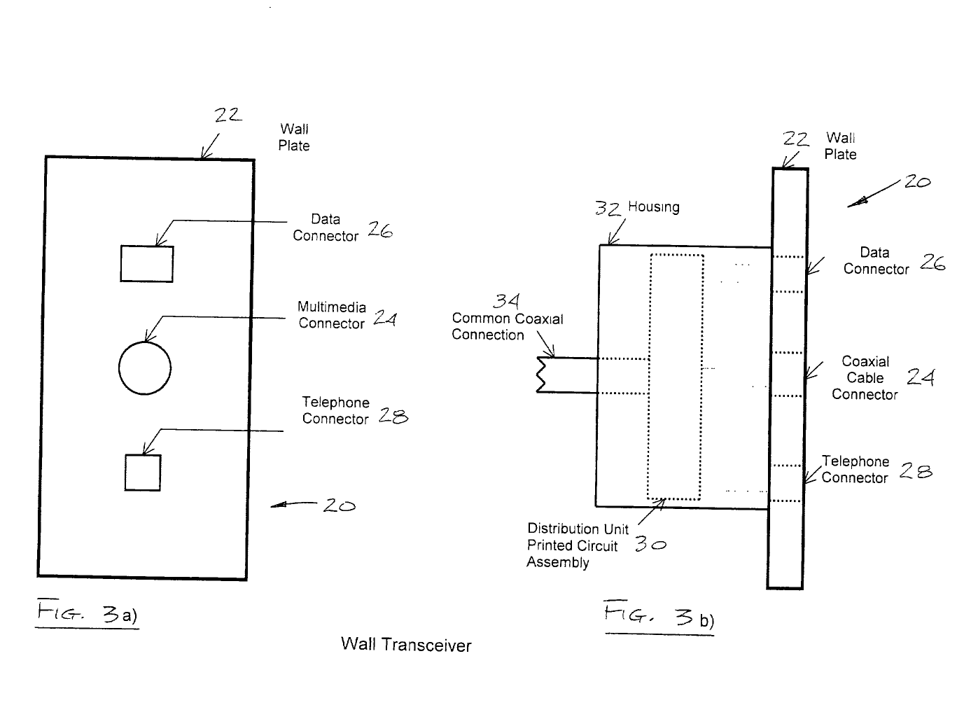

A wall transceiver 20 for the above network is shown in a front view in FIG. 3a and in a side view in FIG. 3b. The transceiver has a wall plate 22 with three individual connections for multimedia 24, data 26 and telephone or access control 28. These connectors 24, 26 and 28 are also mounted onto a single printed circuit assembly 30 contained in a housing 32, which is joined to the wall plate 22. The common coaxial connection 34 enters the rear of the housing 32 and also connects to the circuit assembly 30. In use, the wall plate 22 is mounted to an outside face of a wall and hides the housing 32 which is located within the wall.

In other embodiments of the invention, not all of the above features need be provided by the network and wall transceiver. For instance, one alternative is to combine only data and telephone or control services onto the coaxial cable, in which case both the access multiplexer and the wall transceiver will have the unused function and connections omitted, namely the multimedia connection. In a different embodiment, the wall transceiver may have only a coaxial multimedia connection and one of either a LAN data connection or a telephone connection or an access connection, but both features will still be powered from the access multiplexer.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below.

We claim:

1. A local area network (LAN) architecture and system that combines the distribution of two or more independently or same-sourced classes of services such as multimedia, telephone or access control and data to multiple users within a single building comprising:
a means to convert a primary data service to a radio frequency that is then combined with multimedia and/or a second service into a single LAN network carrying data, analog and digitally enhanced multimedia signals and telephone or access control signals;
a wall plate that performs the necessary interfacing between a terminal and the LAN, between a multimedia entertainment system and the LAN, and a telephone and the LAN, or an access control device and the LAN by means of a radio unit which separates the multimedia, telephone or access control and the data services from each other.
